(19) United States
(12) Patent Application Publication
(10) Pub. No.: US 2022/0119063 A1
(43) Pub. Date: Apr. 21, 2022

(54) SCOOTER BACKPACK AND SCOOTER LUGGAGE DE-ATTACH MECHANISM

(71) Applicant: Elan Travel System LLC, Los Angeles, CA (US)

(72) Inventor: Aryeh RIBAK, Los Angeles, CA (US)

(21) Appl. No.: 17/501,073

(22) Filed: Oct. 14, 2021

Related U.S. Application Data
(60) Provisional application No. 63/092,208, filed on Oct. 15, 2020.

(51) Int. Cl. B62J 9/27; B62K 7/00; B62J 9/21; A45C 15/00; A45C 13/38

(52) U.S. Cl. CPC B62J 9/27; B62K 7/00; A45C 13/385; A45C 15/00; B62J 9/21

(57) ABSTRACT

An method and system of and for releasably affixing a luggage to a column via brackets including posts and apertures either permanently or releasably affixed to the luggage and column.

### CROSS REFERENCE TO RELATED APPLICATIONS

This application claims priority to U.S. 63/092,208 filed Oct. 15, 2020. The contents of this application are incorporated by reference in their entirety.

### FIELD OF THE INVENTION

The present invention relates to a system and method for detachably securing luggage or the like to a wheeled scooter for ease of transport and ease of attachment and removal from a wheeled scooter. Specifically, the instant system and method relates to releasably or detachably securing or affixing a luggage to a scooter, specifically the vertical column of a scooter device.

### BACKGROUND OF THE INVENTION

For those who travel, carrying a heavy bag or suitcase can be problematic at best; and at worst, impossible; especially for those with limited mobility and/or physical wherewithal. Children, for example, suffer from having to carry a backpack or piece of luggage to school or during travel which is heavy and often of a much larger size relative to the child.

Known “wheeled” systems for the transport of luggage and the like include simple multi-wheeled carts, luggage with integrated wheels with telescoping and/or collapsible handles, and the like. However, such systems require a user to either push, pull, and/or walk-along-side the luggage being transported.

Systems are also known wherein a user literally rides a wheeled and powered luggage; however, such systems are more of a novelty rather than a commercially feasible system.

There are no known systems nor methods wherein a luggage or other transport container is detachably affixed to a wheeled scooter; whereby a user may operate the scooter to transport themselves and their luggage to their destination.

It is an object of the invention to overcome the shortcomings of the prior art.

### SUMMARY OF THE INVENTION

The present invention achieves these shortcomings by providing a system and method of and for releasably and/or detachably affixing an article of luggage to a wheeled scooter.

It is an object of the present invention to provide a scooter and corresponding luggage that are attached and/or detached to one another via a latching mechanism.

It is an object of the present invention to provide a scooter that is configured to operate with a latching mechanism to releasably attach to a luggage or backpack.

It is an object of the present invention to provide a luggage or backpack that is configured to operate with a latching mechanism to releasably attach to a scooter.

It is an object of the present invention to provide a latching mechanism that allows the scooter and backpack to be secured to one another.

These and other objects of the invention are achieved through the claims.

These and other objects of the invention are achieved by providing a latching system for detachably affixing a luggage to a column comprising a first bracket affixed the luggage including at least one first post; at least one second bracket affixed to the luggage including at least one second post; at least one third bracket affixed to the column the at least one third bracket including at least one first aperture correspondingly configured to engage the at least one second bracket at least one second post; and at least one moveable bracket affixed to the column including at least at least one second aperture correspondingly configured to engage the at least one first post; whereby, when the at least one second post is inserted into the at least one first aperture, and the movable bracket is displaced to engage the at least one first bracket therein causing the at least second aperture to engage the at least one first post; thereby the luggage is releasably affixed to the column.

In certain embodiments, when the at least one movable bracket is disengaged from the at least one first bracket, the luggage is released and may be removed from the column.

In certain embodiments, when the at least one movable bracket is engaged with the at least one first bracket, the luggage is releasably affixed to the column.

In certain embodiments, the at least one moveable bracket includes a lock to prevent unintentional movement of the at least one movable bracket thus preventing unwanted release of the luggage from the column.

In certain embodiments, the at least one moveable bracket includes a visual indicator that the system is locked and/or unlocked.

In certain embodiments, the at least one moveable bracket includes an audio indicator that the system is locked and/or unlocked.

In certain embodiments, the system posts and/or apertures are correspondingly tapered to provide ease of alignment and engagement.

In certain embodiments, the system post ends are rounded for ease of engagement with corresponding system apertures.

In certain embodiments, the system brackets comprise a material from a group consisting of wood, stone, metal, plastics, polymers, composites, and combinations thereof.

In certain embodiments, the system brackets are of a material which can withstand repeated engagement and disengagement without loss of intended ruggedness nor ease of use.

In certain embodiments, the system brackets are integral to the luggage or column.

In certain embodiments, the system brackets are permanently affixed to the luggage or column.

In certain embodiments, the system brackets are releasably affixed to the luggage or column.

In certain embodiments of the invention, the wheels are configured to move laterally to allow steering left and right.

Other objects of the invention are achieved by providing a scooter-luggage system comprising: a scooter configured to be in a first open position and a second foldable position; and a luggage configured to be attached to the scooter when the scooter is in the first open position, wherein the luggage includes a first bracket affixed the luggage including at least one first post, and at least one second bracket affixed to the luggage including at least one second post; wherein the scooter includes a column having at least one third bracket affixed to the column, the at least one third bracket including at least one first aperture correspondingly configured to engage the at least one second bracket at least one second post, wherein the scooter includes at least one moveable bracket affixed to the column including at least at least one second aperture correspondingly configured to engage the at least one first post; whereby, when the at least one second post is inserted into the at least one first aperture, and the movable bracket is displaced to engage the at least one first bracket therein causing the at least second aperture to engage the at least one first post to releasably affix the luggage to the column.

Other objects of the invention are achieved by providing a scooter comprising: a base and a column having at least one bracket affixed to the column, the at least one bracket including at least one first aperture correspondingly configured to engage at least one bracket on a luggage, and at least one moveable bracket affixed to the column including at least at least one second aperture correspondingly configured to engage at least one first post on the luggage, wherein the scooter is configured to attach to a luggage to releasably attach the scooter to the luggage.

Other objects of the invention are achieved by providing a luggage comprising: a first bracket affixed the luggage including at least one first post, and at least one second bracket affixed to the luggage including at least one second post, wherein the luggage is configured to attach to a scooter to releasably attach the luggage to the scooter.

Other objects of the invention are achieved by providing an attachment-detachment method comprising: providing a first bracket affixed the luggage including at least one first post; providing at least one second bracket affixed to the luggage including at least one second post; providing at least one third bracket affixed to the column the at least one third bracket including at least one first aperture correspondingly configured to engage the at least one second bracket at least one second post; and providing at least one moveable bracket affixed to the column including at least at least one second aperture correspondingly configured to engage the at least one first post; inserting the at least one second post into the at least one first aperture; displacing the movable bracket to engage the at least one first bracket therein causing the at least second aperture to engage the at least one first post to releasably affix the luggage to the column.

Other objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 a perspective view of the scooter luggage assembly of an embodiment of the invention in a closed position.

FIG. 2 depicts an perspective view of FIG. 1 showing the scooter luggage in an open position.

FIG. 3 is a side view of FIG. 1 showing the scooter luggage in an open position.

FIG. 4 a rear view of the scooter luggage in a closed position.

FIG. 5 is a close-up view of the scooter and luggage assembly in a closed position whereby the scooter and luggage are attached to another.

FIG. 6 is a view of a brake for the scooter.

FIG. 7 is an exploded top view of the scooter and luggage assembly in a closed position.

FIG. 8 is an exploded view of the scooter steering column showing movable bracket and locking mechanism.

FIG. 9 is an exploded view of a lower bracket in the scooter steering column showing apertures for receiving posts in the luggage.

FIG. 10 is an exploded view of the scooter steering column showing movable bracket and locking mechanism.

FIG. 11 is an exploded view of the luggage showing an upper bracket having two posts.

FIG. 12 is an exploded view of the luggage showing a lower bracket having two posts.

FIG. 13 shows an exploded view of the scooter steering column whereby the moveable bracket is configured to slide up and receive posts from the luggage.

### DETAILED DESCRIPTION OF THE INVENTION

The appendices to this application are incorporated by reference in their entirety.

In the following description, numerous details are set forth for the purpose of explanation. However, one of ordinary skill in the art will realize that the invention may be practiced without the use of these specific details.

As depicted in the Figures, it is contemplated that the inventive method and system for releasably affixing a luggage (105), such as a suitcase, luggage, or other transport container, to a column (110) such as a steering column of a wheeled scooter, may comprise a first bracket (115) affixed to the luggage (105) including at least one first post (120); at least one second bracket (125) affixed to the luggage (105) including at least one second post (130); at least one third bracket (135) affixed to the column (110) the at least one third bracket (135) including at least one first aperture (140) correspondingly configured to engage the at least one second bracket (125) at least one second post (130); and at least one moveable bracket (145) affixed to the column (110) including at least at least one second aperture (150) correspondingly configured to engage the at least one first post (120); whereby, when the at least one second post (130) is inserted into the at least one first aperture (140), and the movable bracket (145) is displaced to engage the at least one first bracket (115) therein causing the at least second aperture (150) to engage the at least one first post (120); thereby the luggage (105) is releasably affixed to the column (110).

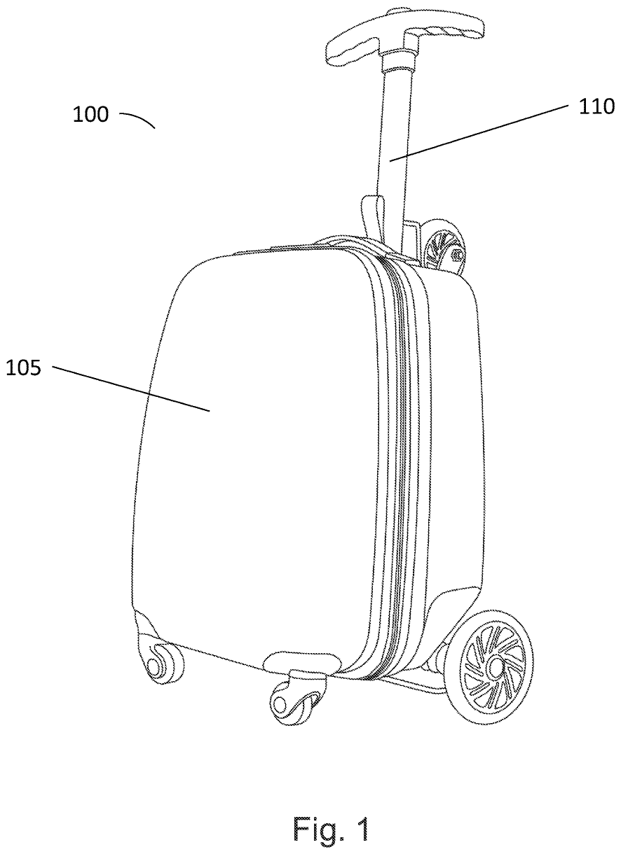

FIG. 1 shows the scooter luggage assembly having luggage (105) attached to scooter in a closed position. The scooter is shown being folded such that its rear wheel is shown raised and secured to the scooter steering column.

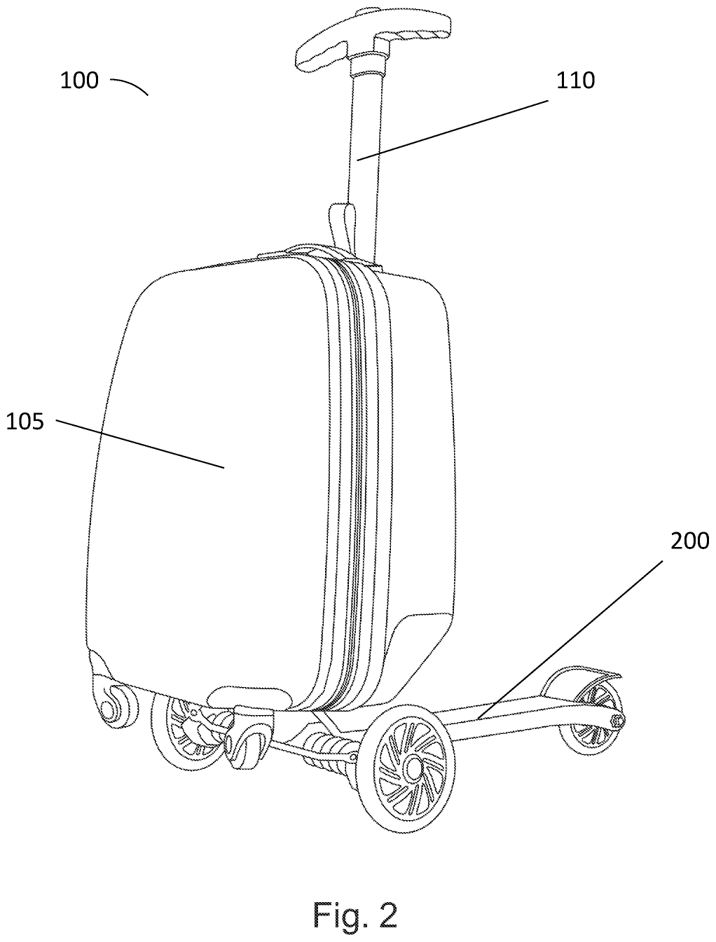

FIG. 2 shows the scooter (200) luggage assembly in an open position with the luggage (105) attached thereto. A user can ride the scooter (200) in this position, thus allowing transport of the luggage (105).

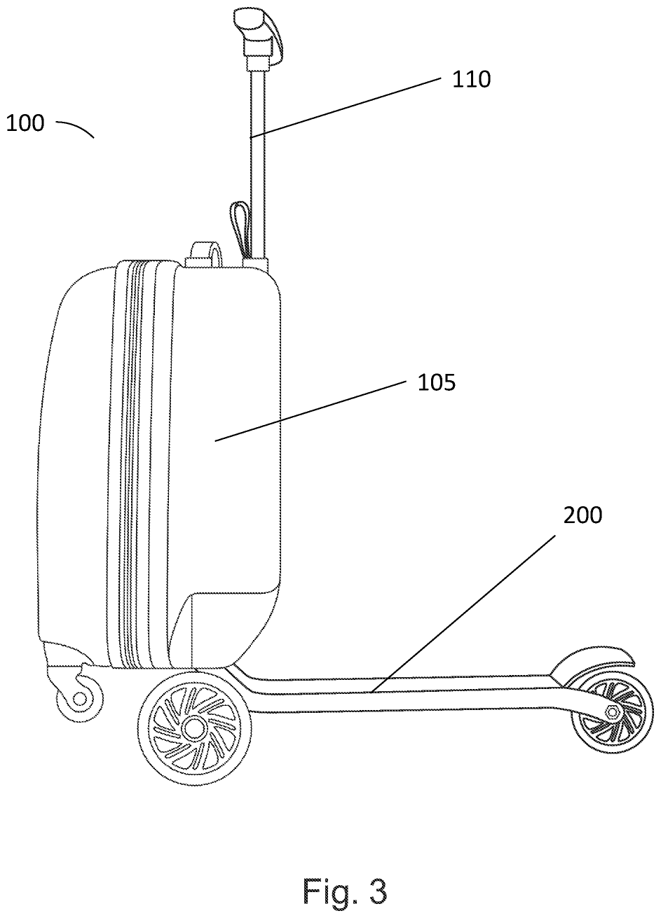

FIG. 3 is a side view of FIG. 1 showing the scooter (200) in an open position. Here the scooter (200) is shown having the luggage (105) attached thereto and providing clearance between the wheels of the luggage (105) and the ground, thus allowing for the scooter (200) to provide transport of the luggage (105).

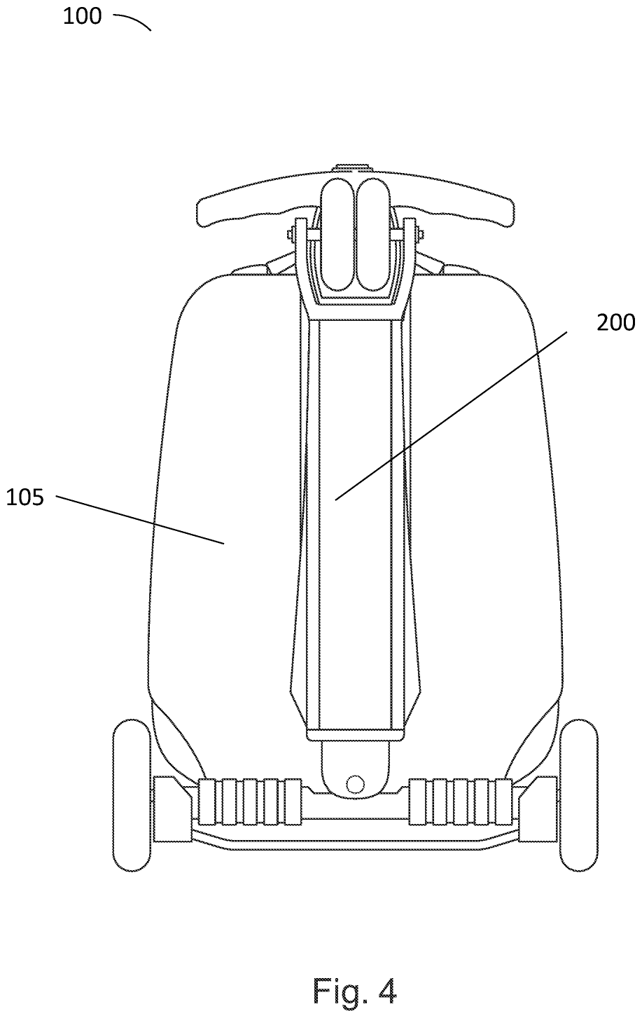

FIG. 4 a rear view of the scooter (200) in a closed position. Here the scooter (200) is shown being folded such that its rear wheel is shown raised and secured to the scooter (200) steering column.

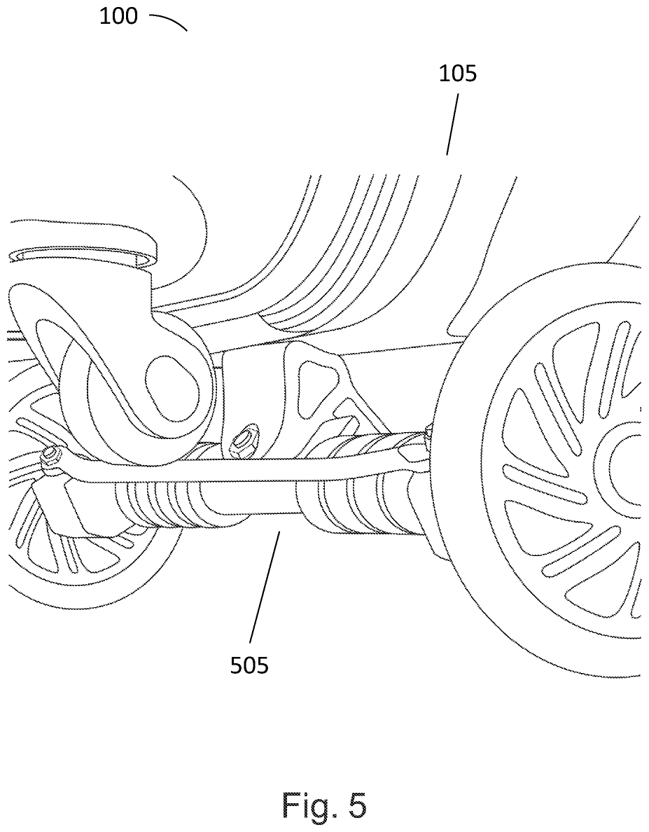

FIG. 5 is a close-up view of the scooter (200) and luggage (105) assembly in a closed position whereby the scooter (200) and luggage (105) are attached to another. The front axle and wheel assembly (505) of the scooter (200) is shown supporting the scooter (200) and providing structural integrity to the assembly.

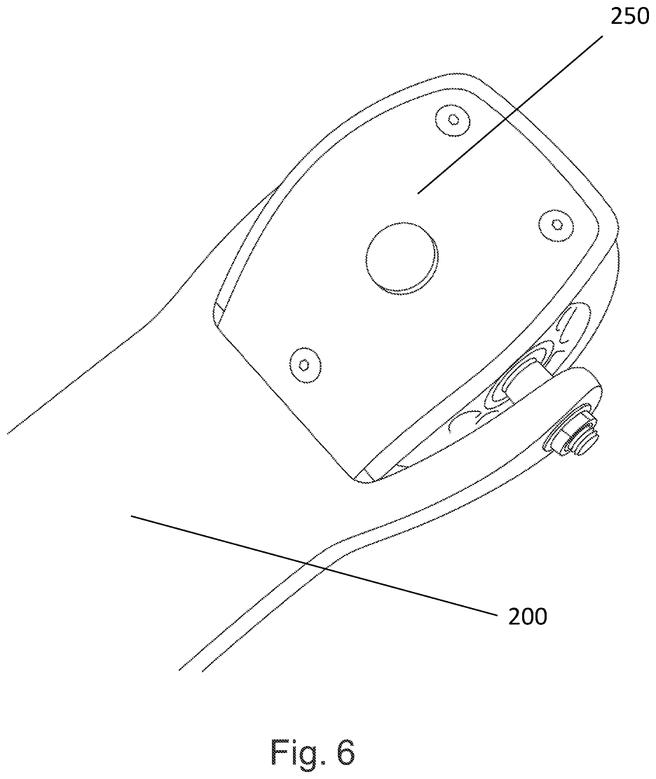

FIG. 6 is a view of a rear brake (250) for the scooter (200). A user can press on the rear brake (250) so to provide friction to the rear wheel of the scooter (200) to stop the movement of the scooter (200).

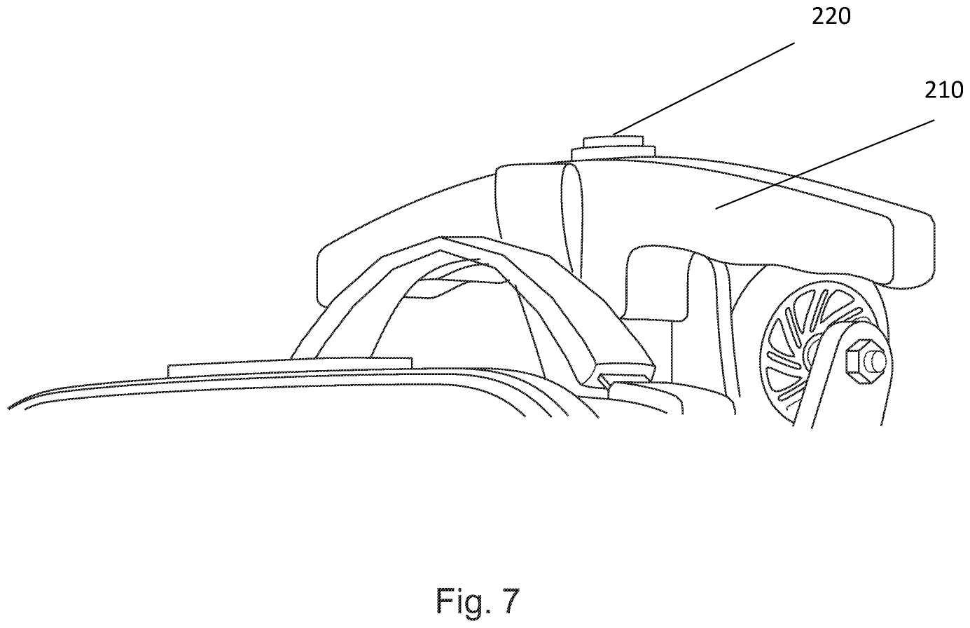

FIG. 7 is an exploded top view of the scooter (200) and luggage (105) assembly in a closed position. Here the scooter handle (210) is shown with button (220) that allows the scooter to be locked and unlocked from an open to a closed position.

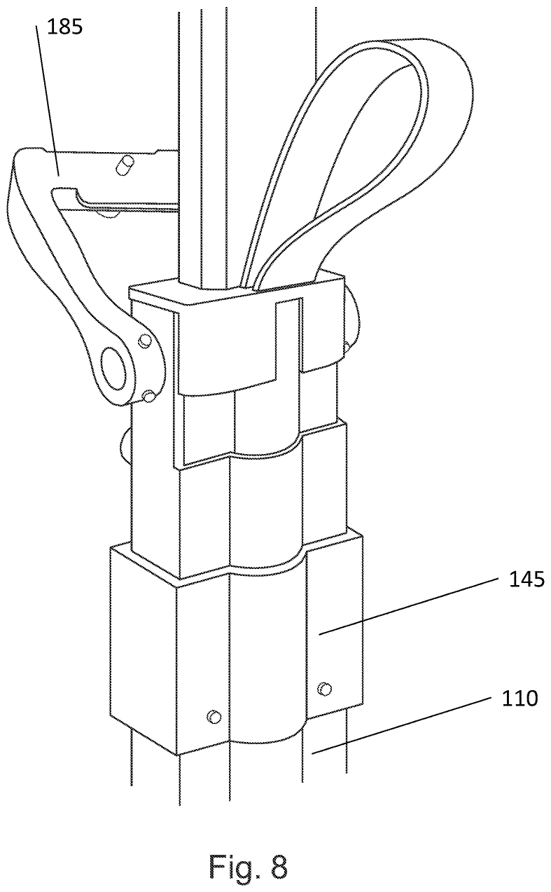

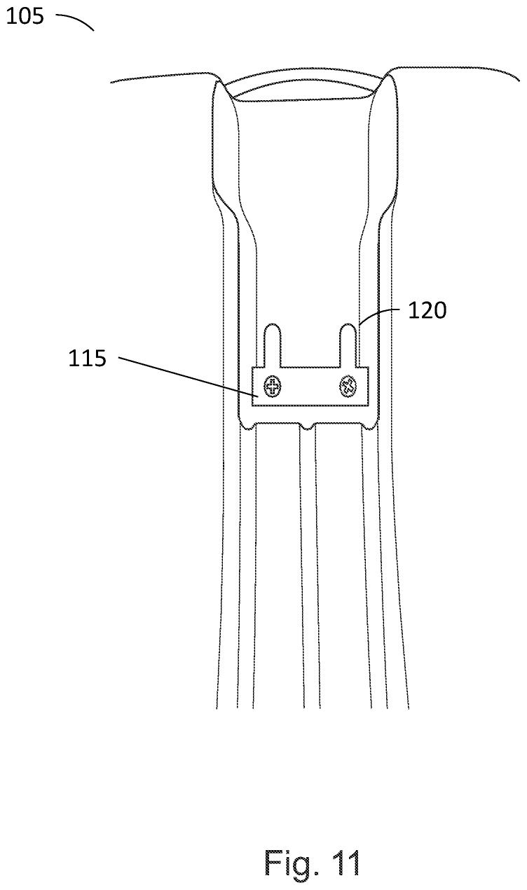

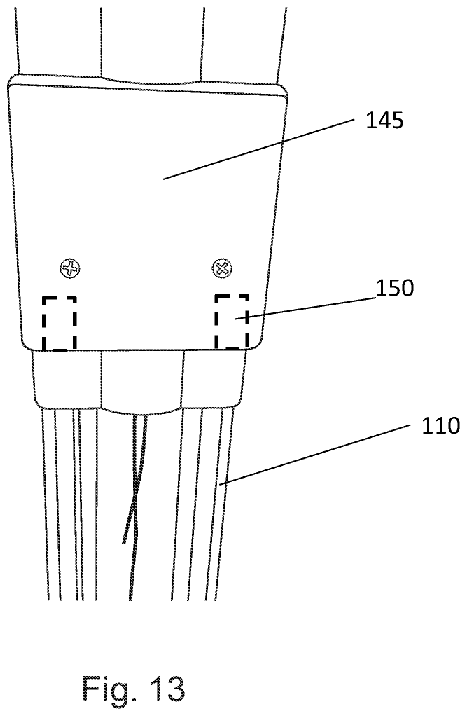

FIG. 8 shows steering column (110) which supports moveable bracket (145) and locking member (185). The moveable bracket (145) is configured to move upwards in order to receive a corresponding bracket (115) and at least one post (120) on the luggage as shown in FIGS. 11 and 13.

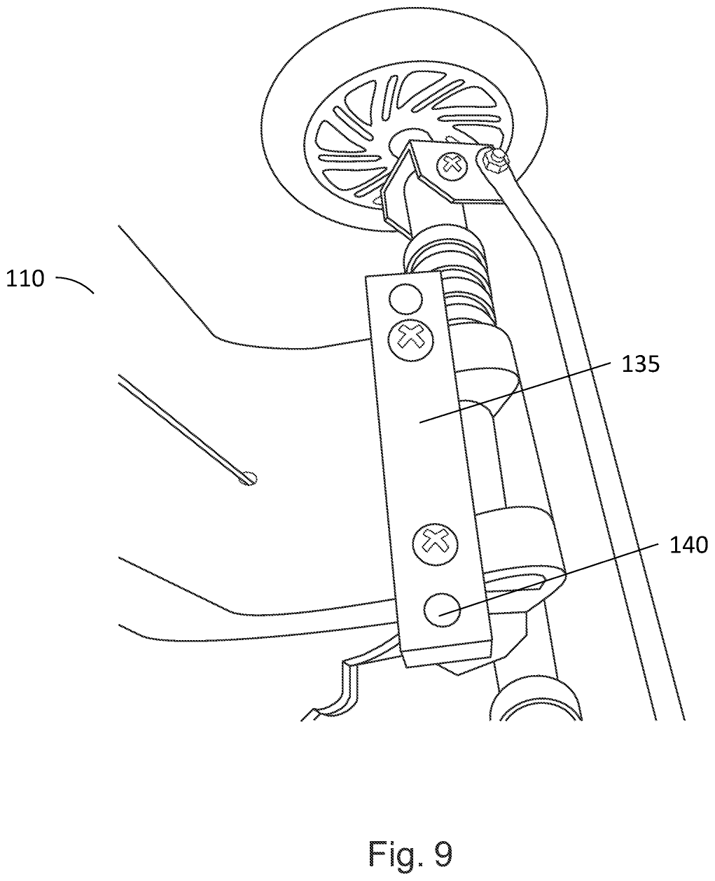

FIG. 9 is an exploded view of a lower bracket (135) in the scooter (200) steering column (110) showing apertures (140) for receiving posts (130) in the luggage (105).

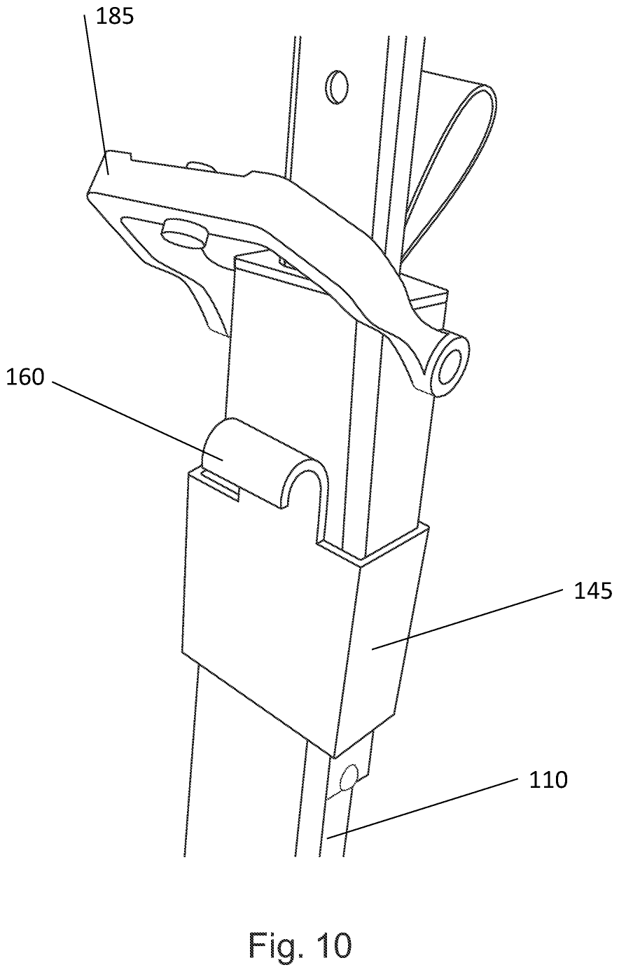

FIG. 10 shows the shows steering column (110) from the opposite side. Here the moveable bracket (145) is configured to slide upward via pull handle (160) such that the at least one post (120) on the luggage (105) enters slots or apertures (150) in the moveable bracket (145) as shown in FIG. 13.

FIG. 11 is an exploded view of the luggage (105) showing an upper bracket (115) having two posts (120). The two posts (120) configured to slide into apertures (150) in the moveable bracket (145) as shown in FIG. 13.

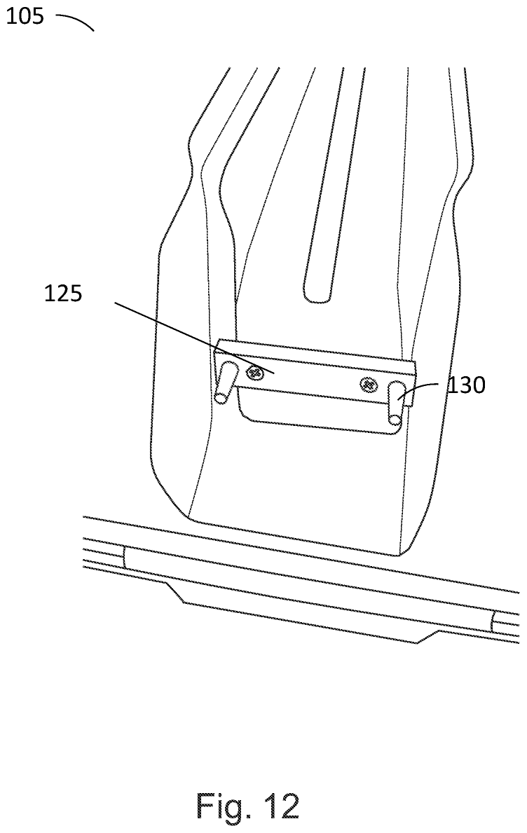

FIG. 12 is an exploded view of the luggage (105) showing a lower bracket (125) having two posts (130). The two posts (130) are configured to slide into in the apertures (140) in the second bracket (135) as shown in FIG. 9.

FIG. 13 shows an exploded view of the scooter (200) steering column (110) whereby the moveable bracket (145) is configured to slide downwards and receive posts (120) from the luggage (105) into apertures (150). In this manner, the posts 120 slide into apertures (150) of the moveable bracket (145) thus securing the luggage (105) to the steering column (110) of the scooter (200).

Having thus described several embodiments for practicing the inventive method, its advantages and objectives can be easily understood. Variations from the description above may and can be made by one skilled in the art without departing from the scope of the invention.

Accordingly, this invention is not to be limited by the embodiments as described, which are given by way of example only and not by way of limitation.

What is claimed is:

1. A latching system (100) for affixing a luggage (105) to a column (110) comprising:
a first bracket (115) affixing the luggage (105) including at least one first post (120);
at least one second bracket (125) affixed to the luggage (105) including at least one second post (130);
at least one third bracket (135) affixed to the column (110), the at least one third bracket (135) including at least one first aperture (140) correspondingly configured to engage the at least one second bracket (125) at least one second post (130); and
at least one moveable bracket (145) affixed to the column (110) including at least at least one second aperture (150) correspondingly configured to engage the at least one first post (120);
whereby, when the at least one second post (130) is inserted into the at least one first aperture (140), and the movable bracket (145) is displaced to engage the at least one first bracket (115) therein causing the at least second aperture (150) to engage the at least one first post (120);
thereby the luggage (105) is releasably affixed to the column (110).

2. The system of claim 1, wherein when the at least one movable bracket (145) is disengaged from the at least one first bracket (115), the luggage (105) is released and may be removed from the column (110).

3. The system of claim 1, wherein when the at least one movable bracket (145) is engaged with the at least one first bracket (115), the luggage (105) is releasably affixed to the column (110).

4. The system of claim 1, wherein the at least one moveable bracket (145) includes a lock to prevent unintentional movement of the at least one movable bracket (145), thus preventing unwanted release of the luggage (105) from the column (110).

5. The system of claim 4, wherein the at least one moveable bracket (145) includes a visual indicator that the system is locked and/or unlocked.

6. The system of claim 4, wherein the at least one moveable bracket (145) includes an audio indicator that the system is locked and/or unlocked.

7. The system of claim 1, wherein the system posts and/or apertures are correspondingly tapered to provide ease of alignment and engagement.

8. The system of claim 1, wherein the system post ends are rounded for ease of engagement with corresponding system apertures.

9. The system of claim 1, wherein the system brackets comprise a material from a group consisting of wood, stone, metal, plastics, polymers, composites, and combinations thereof.

10. The system of claim 1, wherein the system brackets are of a material which can withstand repeated engagement and disengagement without loss of intended ruggedness nor ease of use.

11. The system of claim 1, wherein the system brackets are integral to the luggage or column.

12. The system of claim 1, wherein the system brackets are permanently affixed to the luggage or column.

13. The system of claim 1, wherein the system brackets are releasably affixed to the luggage or column.

14. A scooter-luggage system comprising:
a scooter; and
a luggage configured to be attached to the scooter,
wherein the luggage includes a first bracket (115) affixed the luggage (105) including at least one first post (120), and at least one second bracket (125) affixed to the luggage (105) including at least one second post (130);
wherein the scooter includes a column (110) having at least one third bracket (135) affixed to the column (110), the at least one third bracket (135) including at least one first aperture (140) correspondingly configured to engage the at least one second bracket (125) at least one second post (130),
wherein the scooter includes at least one moveable bracket (145) affixed to the column (110) including at least at least one second aperture (150) correspondingly configured to engage the at least one first post (120);
whereby, when the at least one second post (130) is inserted into the at least one first aperture (140), and the movable bracket (145) is displaced to engage the at least one first bracket (115) therein causing the at least second aperture (150) to engage the at least one first post (120) to releasably affix the luggage (105) to the column (110).

15. A scooter comprising:
a base (200) and a column (110) having at least one bracket (135) affixed to the column (110), the at least one bracket (135) including at least one first aperture (140) correspondingly configured to engage at least one bracket on a luggage, and
at least one moveable bracket (145) affixed to the column (110) including at least at least one second aperture (150) correspondingly configured to engage at least one first post on the luggage,
wherein the scooter is configured to attach to a luggage to releasably attach the scooter to the luggage.

16. A luggage to scooter attachment-detachment method comprising:
providing a scooter-luggage system according to claim 14;
inserting the at least one second post (130) into the at least one first aperture (140); and
displacing the movable bracket (145) to engage the at least one first bracket (115) therein causing the at least second aperture (150) to engage the at least one first post (120) to releasably affix the luggage (105) to the column (110).
